(19) United States
(12) Patent Application Publication
(10) Pub. No.: US 2013/0289886 A1
(43) Pub. Date: Oct. 31, 2013

(54) Calorie Monitoring System

(71) Applicant: Nathan W. Ricks, Lehi, UT (US)

(72) Inventor: Nathan W. Ricks, Lehi, UT (US)

(21) Appl. No.: 13/871,973

(22) Filed: Apr. 26, 2013

Related U.S. Application Data
(60) Provisional application No. 61/638,926, filed on Apr. 26, 2012.
(60) Provisional application No. 61/729,084, filed on Nov. 21, 2012.

(51) Int. Cl. G06F 17/00

(52) U.S. Cl. CPC G06F 17/00
USPC 702/19

(57) ABSTRACT

Systems and methods for measuring calorie consumption and expenditure is disclosed. The system includes a peripheral device and a smart device. The peripheral device has one or more motion sensors and one or more weight sensors. The smart device is in electronic communication with the peripheral device and is configured to calculate calorie consumption and expenditure of a user based on data measured from the one or more motion sensors and one or more weight sensors.

### BACKGROUND

1. Field of the Invention

This invention relates generally to systems and methods for calculating and monitoring the calorie intake, caloric output, and consumption of an individual. More specifically, this invention relates to systems and methods for using a peripheral device that can serve the dual function of measuring individual activity and functioning as a food scale. Some implementations can be utilized with a smart device (e.g., a smart phone) to calculate and display the individual's calorie intake and expenditures.

2. Background

The benefits of managing one's weight, eating properly, and maintaining an active lifestyle are well known and researched. These benefits include a low propensity to illness and disease and prolonged life expectancy. Despite these advantages, the general population is experiencing an increase in body weight and a decline in many aspects of its health. One potential cause of this trend is lack of reliable feedback available to specific individuals about various aspects of their health. For instance, while many people understand the need for healthy habits, they often do not recognize the effect of their various daily lifestyle choices and unhealthy habits. Instead, other priorities can divert an individual's focus from health to other cares. As a result, well-intentioned individuals may unintentionally become heavier and less healthy.

To address these challenges, hundreds of fad diets and weight-loss plans promise quick and easy weight loss and good health. These programs try to make weight loss and good health easier, quicker, cheaper, more reliable, and less painful. While these programs can be effective and beneficial, they are often short lived and do not promote long-term health and wellness. These programs can also take an individual's focus off of the more fundamental and essential elements of health and wellness, including healthy eating habits, exercise, and physical activity.

Additionally, because many health problems develop over long periods of time, some people are unaware of the negative effects of their lifestyle choices. For instance, because many individuals feel good or are content with their overall appearance and body weight they fail to recognize or address their unhealthy lifestyle practices. These individuals may later experience serious health problems that may have been avoided if they had understood the effects of their lifestyle choices or if they had been advised of their potential for illness and advised to make preventative changes.

Thus, while current health programs and systems are available, improvements would be desirable.

### SUMMARY

The present invention has been developed in response to problems and needs in the art that have not yet been fully resolved by currently available systems and methods. Thus, these systems and methods are developed to provide individuals with a calculation of their overall calorie intake and expenditure. This information can be provided to individuals in real time, to enable them to recognize the effect of their daily choices on their health.

Some aspects of the present invention include a calorie monitoring system that includes a smart device, such as a smart phone, in electronic communication with a peripheral device. The peripheral device can serve the dual functions of measuring user activity and serving as a food scale. Accordingly, the peripheral device can include one or more weight sensors for weighing food that is eaten by the user. The one or more motion sensors can include, for example, one or more accelerometer, altimeter, magnetometer, pedometer, tilt sensor, and/or global positioning system (GPS) device. The motion sensors can be used to measure the motion of a user during the day, or even at night.

Data from the peripheral device can be transmitted to a smart device (e.g., a smart phone) using one or more communication links, such as a wired or wireless link (e.g., a Bluetooth connection, Near Field Communication (NFC)). The smart device can utilize this information to calculate the calorie intake and calorie expenditure of the user. For example, the smart device can estimate a user's calorie intake based on the difference between the starting weight and the ending weight of weighed food items. This information can be collected, for instance, when a user ways a food or drink item before consuming the food or drink item. Using these measurements, the smart device can calculate the weight of food consumed. The smart device can also take a picture of the food at the time it is weighed. The smart device can also scan a barcode of packaged food. These inputs can assist to identify the food being weighed in order to provide a more accurate calorie calculation. The user can optionally input the type of food or the specific identify of the food to provide more accurate measurements. In another example, the smart device can estimate a user's calorie expenditures based on the activity measurements taken by the one or more motion sensors of the peripheral device. A representative peripheral device can be configured to measure and/or display the number of steps taken by the user, the flights of stairs traveled by the user, the number of calories burned by the user, the overall distance traveled by the user, and the time of day.

These and other features and advantages of the present invention may be incorporated into certain embodiments of the invention and will become more fully apparent from the following description and appended claims, or may be learned by the practice of the invention as set forth hereinafter. The present invention does not require that all the advantageous features or every advantage described herein be incorporated into every embodiment of the invention.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings.

FIG. 1 illustrates a perspective view of a representative calorie monitoring system that includes a peripheral device and a smart device, accordingly to some embodiments of the present invention.

FIG. 2 illustrates a perspective view of a representative peripheral device with internal components shown in phantom lines, accordingly to some embodiments of the present invention.

FIGS. 3A and 3B illustrate perspective views of a representative peripheral device in use as a food scale, accordingly to some embodiments of the present invention.

FIGS. 4A and 4B illustrate perspective views of representative peripheral devices incorporated into key chains, accordingly to some embodiments of the present invention.

FIGS. 5A, 5B, and 5C illustrate perspective views of representative peripheral devices incorporated into a pocket watch and belt clip, accordingly to some embodiments of the present invention.

FIGS. 6A and 6B illustrate perspective views of representative peripheral devices incorporated into a purse clip, accordingly to some embodiments of the present invention.

FIGS. 7A and 7B illustrate perspective views of representative peripheral devices incorporated into a watch, accordingly to some embodiments of the present invention.

FIG. 8 illustrates a perspective view of another representative system that includes a food scale device and a smart device, accordingly to some embodiments of the present invention.

FIG. 9 illustrates a perspective view of yet another representative system that includes a food scale device and a smart device, accordingly to some embodiments of the present invention.

### DETAILED DESCRIPTION OF THE INVENTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B, and C).”

Various operations may be described as multiple discrete operations in turn, in a manner that may be helpful in understanding embodiments of the present invention; however, the order of description should not be construed to imply that these operations are order dependent.

The description may use the phrases “in an embodiment,” or “in various embodiments,” “in some configurations,” or “in some instances,” which may each refer to one or more of the same or different embodiments, configurations, or instances. Furthermore, the terms “comprising,” “including,” “having,” and the like, as used with respect to embodiments of the present invention, are synonymous with the definition afforded the term “comprising.”

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical or electrical contact. However, “coupled” may also mean that two or more elements are not in direct contact with each other, but yet still cooperate or interact with each other.

This invention relates generally to systems and methods for calculating and monitoring the calorie intake, caloric output, and consumption of an individual. More specifically, this invention relates to systems and methods for using a peripheral device that can serve the dual function of measuring individual activity and functioning as a food scale. Some implementations can be utilized with a smart device (e.g., a smart phone) to calculate and display the individual's calorie intake and expenditures. A representative peripheral device can be configured to measure and/or display the number of steps taken by the user, the flights of stairs traveled by the user, the number of calories burned by the user, the overall distance traveled by the user, and the time of day.

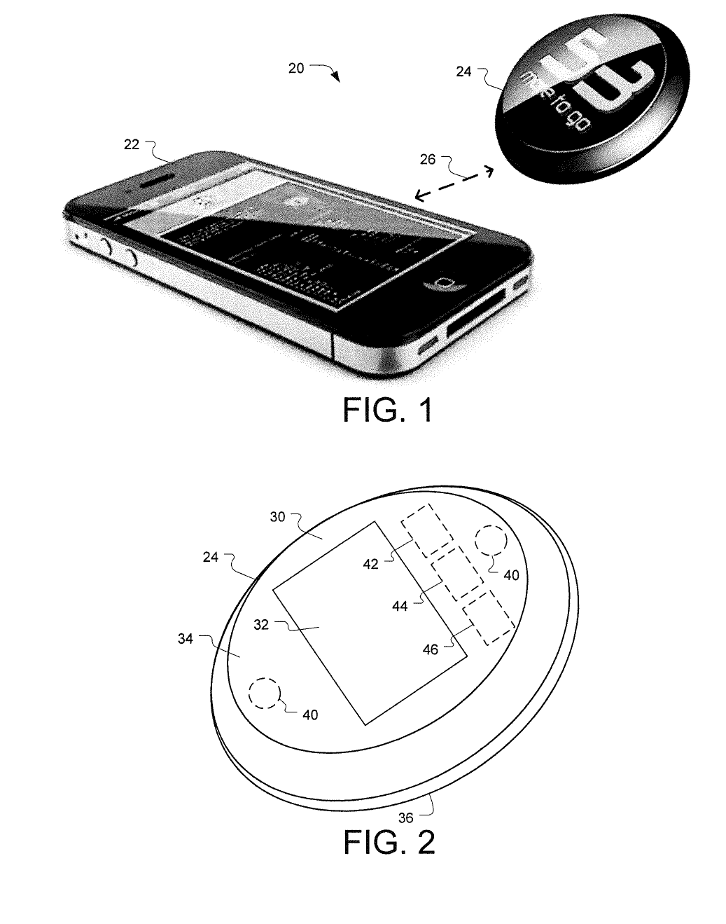

Reference will first be made to FIG. 1, which illustrates a calorie monitoring system (or simply “system”) 20 that includes a smart device 22 and a peripheral device 24. The smart device 22 can include a smart phone, tablet computer, laptop, or other suitable portable computer system. The smart device 22 can be electronically coupled to the peripheral device 24 using a communication link 26. In general, the system 20 is configured to provide users with a calculation of their overall calorie intake and expenditure for a given period, such as a day. This information may be provided to individuals to enable them to recognize the effect that their lifestyle choices have on their overall health. By providing users with accurate and even fairly real-time information about their overall calorie intake and expenditure, the user can more effectively manage his/her weight and overall health. This system 20 can thus avoid the downsides of temporary health fads by offering actual, measurable information that can be used to form enduring, effective, and improved lifestyle changes. This information can empower the users to managing their weight, eat properly, and maintaining an active lifestyle in order to reduce their propensity to illness and disease and prolong their life expectancy.

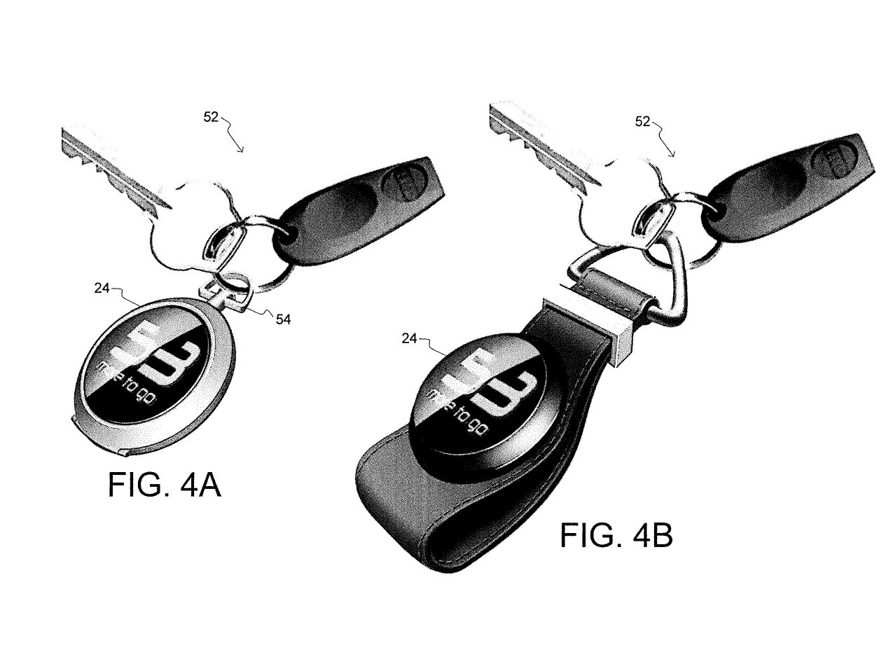

Specific reference will now be made to the peripheral device 24, which is illustrated in FIG. 1. This device can be designed to be carried or worn by a user. Non-limiting examples of ways to carry and wear the peripheral device 24 are shown in FIGS. 4A-7B, which are described below. Additionally, the peripheral device 24 can be configured as an anklet, bracelet, clip, finger ring, toe ring, pendant, necklace, earring or other piercing, implant, or other attachable, wearable, or carry-able device. When carried, the peripheral device 24 can measure the user's activity, such as steps taken, calories burned, stairs ascended or descended, activity duration, and/or distance traveled. The peripheral device 24 may additionally or alternatively be configured to measure a user's heart rate and/or glucose levels.

Referring to FIG. 2, the peripheral device 24 can include a housing 30 that houses the various components of the peripheral device 24. For example, the housing 30 can contain a display 32 for displaying information, data, and messages to the user. The display 32 can cover the entire top surface 34 of the housing or a portion of the top surface 34. The housing 30 can also contain one or more weight sensors 40, one or more motion sensors 42, one or more processors 44, one or more memory devices 46, and/or other suitable components and sensors.

In some embodiments, the housing 30 can be robust and/or water proof/resistant to resist impact damage, heat damage, and water damage that may be associated with daily use and transport. In embodiments with waterproof housings, the housing can include one or more exterior waterproof coating, waterproof tape, waterproof seals about housing junctions, and other known and future developed waterproofing mechanisms.

In some embodiments, the peripheral device 24 can be shaped and sized to be conveniently carried, toted, or attached to a user. For example, the peripheral device 24 can have a maximum length between approximately 1 and approximately 4 inches, approximately 1 and approximately 3.5 inches, or approximately 1.5 and approximately 3 inches. The peripheral device 24 can have a maximum width between approximately 0.5 and approximately 2.5 inches, approximately 0.75 and approximately 2 inches, or approximately 1 and approximately 1.5 inches. The peripheral device 24 can have a maximum thickness between approximately 0.1 and approximately 1 inch, approximately 0.2 and approximately 0.7 inches, approximately 0.25 and approximately 0.6 inches.

As shown, the peripheral device 24 can include one or more motion sensors 40 that measure users' physical motion. These motion sensors 40 can include one or more accelerometer, altimeter, magnetometer, pedometer, tilt sensor, and/or global positioning system (GPS) device. Each of the motion sensors can measure one or more complements of motion including, for example, changes in elevation, changes in direction, changes in acceleration, and/or changes in location. Raw measurement data from one or more motion sensors 40 can be processed in the peripheral device 24, using one or more processors 44. Data measured or processed in the peripheral device 24 can be stored within one or more memory devices 46. Alternatively, this data can be transmitted to the smart device 22, as shown in FIG. 1, for processing. The measured or processed data can be continuously or periodically uploaded to the smart device 22. The smart device 22 can ultimately display activity or calorie related information to the user.

In addition to using information about the user's physical movement to determining calorie expenditure, the system 20 can utilize information about the user's body temperature, heart rate, and/or blood pressure. For example, the peripheral device 24 can include a temperature sensor (not shown) for measuring the user's body temperature. Body temperature measurements can be used to determine the physical activity level of the users, since physical activity can generate body heat. In some configurations, the temperature sensor can include one or more electrodes or other contact surface that can be placed in contact with the user's skin. Electrodes can be disposed on a surface of the peripheral device 24, including the bottom surface 36. When electrodes are placed on the bottom surface 36, the top surface, or face, of the peripheral device 24 can be presented to the user. The one or more electrodes can include a thermocouple, thermister, or other temperature sensor to detect temperature levels of the user's skin surface.

Heart rate can be measured using one or more a heart rate monitor devices. Heart rate is the number of heartbeats per unit of time (e.g., a minute). Heart rate measurements can assist to determine the level of health of the user and to diagnose and track medical conditions. For instance, healthy or active individuals may have a lower resting heart rate than less active or less healthy individuals. Accordingly, in some embodiments, the body attachment 20 can include an electrocardiogram (ECG or EKG) or other device for measuring the user's heart rate. Some configurations may also utilize a pulse oximeter to measure pulse and/or blood pressure. A pulse oximeter can include one or more light sources (e.g. light-emitting diodes) that transmit light into the skin of a patient. The pulse oximeter can also include one or more detectors, such as a photo detector that detects light reflected from an underlying artery. By processing the character of the reflected and the transmitted lights, the pulse oximeter can identify and measure various features of the user's blood, including the user's heart rate and/or blood pressure.

Blood pressure is one of the principle vital signs and can provide useful health information to the user and health professionals. Blood pressure is the pressure that blood exerts upon blood vessel walls within the body. During a heartbeat, blood pressure rises from a diastolic pressure to a systolic pressure, each of which can be measured and tracked by the health measurement system. Healthy users can have lower diastolic and systolic blood pressure values. By knowing their blood pressure measurements users can gauge their stress levels and then work to achieve and maintain healthy blood pressure levels. In some embodiments, the activity measuring system can measure the user's blood pressure using a pulse oximeter or other suitable device.

Some embodiments of the peripheral device 24 can include one or more devices for measuring the user's blood glucose levels. Blood glucose levels, which indicate the amount of glucose in the blood, can be important information for users with diabetes. For instance, in some configurations, the system 20 can incorporate an external glucometer that can interface and communicate with the system 20. For example, an external glucometer can communicate with one or more components of the system 20 via a short-range wireless link (e.g., a Bluetooth link). Blood glucose levels can be received, stored, and/or transmitted by the peripheral device 24 when the external glucometer is located within a minimum range in which the wireless link can be established.

As mentioned, after the peripheral device 24 measures the user's activity, heart rate, body temperature, and/or blood pressure, this information can be transmitted to the smart device via a communication link 26, shown in FIG. 1. This communication link 26 can be a wireless or direct-wired communication link. For example, in some configurations, this communication link can be a short-range wireless link, such as a Bluetooth link. In some embodiments, the peripheral device 24 and the smart device can communicate data using near field communication standards.

In some configurations, the peripheral device 24 can upload data to the smart device 22 continuously or periodically when it is in proximity to the mobile communication device 12, such as within an operable distance, such as within a range of about 5 feet, 10 feet, 15 feet, 20 feet, 25 feet, or farther. Such wireless communication can enable easy and rapid data transmission. In other configurations, this second communication link can be a wired communication link, such over cable. The wired communication link can be coupled to an earphone port or other port of the smart device 22. A wired connection can advantageously charge any batteries within the peripheral device 24.

It will be understood, that the system 20 may be further configured to provide additional information to users, in addition to calorie intake and expenditure. For example, the system 20 can be used at night to track and analyze users' sleep activity and patterns. The system 20 can also provide various other health metrics that can educate a user on their current health status. The smart device 22 can also be used to analyze the users' health measurements and provide tips, suggestions, and motivation. Moreover, the smart device 22 can transmit the users' health measurements to third parties or other computer systems for analysis and the like.

In some particular embodiments, the system 20 can be configured to track a user's health measurements against a set of goals established by the user. The system 20 can be configured to provide the user with feedback, historical data, and motivation. For examples, as shown in FIG. 1, the peripheral device is displaying the text, “53 more to go”. This message may indicate to the user the number of calories left to expend in a day in order to meet a daily goal. This information can be provided in real time, as the system 20 calculates the user's calorie expenditures during physical activity. Various other such features can be provided by the system 20.

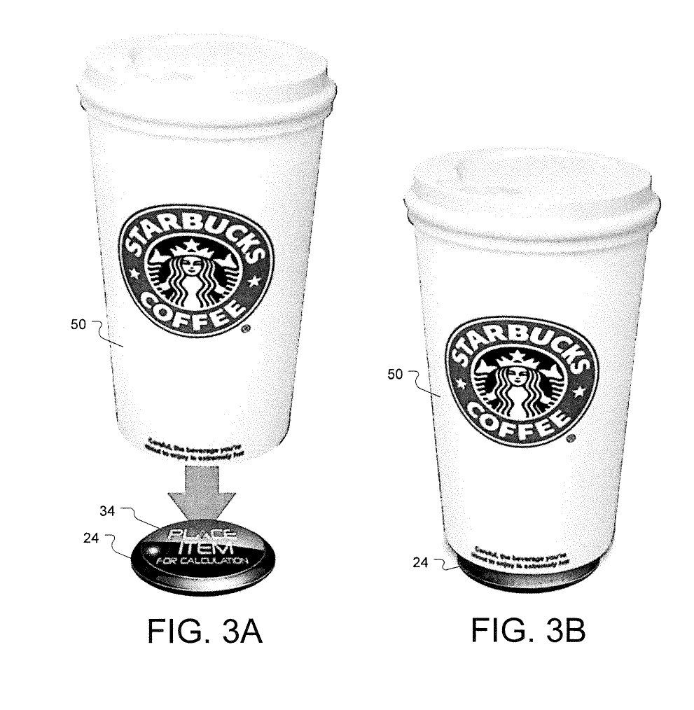

Reference will now be made to FIGS. 3A and 3B, which illustrate the capabilities of the peripheral device 24 to measure the weight of the food that is consumed by users. As shown in FIG. 2, the peripheral device 24 can include one or more weight sensors 40. These weight sensors 40 can enable the peripheral device to act as a food and drink scale for weighing food and using the weight to estimate the food or drink's calorie content. As shown in FIGS. 3A and 3B, the bottom surface 36 of the peripheral device 24 can be placed on a relatively flat surface, such as a table. A food item 50 (herein “food item” refers to food items, drink items, and food or drink items in or on containers or serviceware) can then be placed on the top surface 34 of the peripheral device 24. The food item 50 can be temporarily placed on the peripheral device 24 or left for prolonged periods, such as the duration of the meal.

To calculate the number of calories consumed by a user, the user can place each food item 50 on the peripheral device 24 to be weighed before the user consumes the food item 50, as shown. If the user chooses not to consume the entire food item, the uneaten portion can be weighed by the user. When food is included on or in a cup, bowl, plate, saucer, or other item of serviceware, the serviceware can be placed on the peripheral device 24 to way the entire amount of food along with the serviceware. This weighing process can be performed before the user begins to consume the food item 50 as well as after the user is done. These two measurements can be used to recognize the weight of the serviceware along with any unconsumed portions of the food item. The difference between the initial and final weights can be calculated to determine the weight of the food consumed.

In some instances, a user may want to weigh a plate of food containing multiple food items 50, which cannot be weighed separately. In these instances, the plate holding the various food items 50 can be weighed. After the user has completed the meal, the weight of the plate can be re-measured, and the difference between the starting weight and the ending weight can be determined. To improve the accuracy of the calorie estimation, the user can input into the smart device 22 the types of food items included on the plate and optionally the relative portion sizes of the food items. If the user does not provide this input, the smart device 22 can provide an estimate based on known averages for food generically. After the meal, if all of the food items 50 are not eaten, the user can input into the smart device 22 what food items 50 in the meal were not eaten and/or how much of each food item 50 was not eaten. In some instances, the plate, cup, or other serviceware item can be left of the peripheral device 24 during an entire meal, during which time the weight of the food item(s) 50 can be monitored. This continuous weighing can recognize when a user gets “seconds” or refills.

Various tools and features can be provided or utilized to assist the smart device 22 in determining the number of calories within weighed food. For example, when smart devices 22 include a GPS or other location-finding tool, the smart device 22 can identify the user's location where the food item 50 is being measured. If the smart device 22 identifies the location as being within a restaurant, the smart device 22 can use known averages of calories based on food from that facility or food of that type of facility. If the smart device 22 has access to or knows the menus items and/or calorie content of menu items, the smart device 22 can ask the user to select the menu item being weighed, from the list of menu items. The smart device 22 can combine this information with the weight of the food to provide an accurate estimate of the number of calories consumed. In another example, the user can take a picture of the food item(s) with a camera on the smart device 22 as the food is being weighed. This process can be repeated if the food item is re-weighed after the user finished eating the food item. The weight of the food item along with the picture(s) can be transmitted to a server where it is automatically or manually inspected to identify the type of food and an estimate of the calories in that type of food. Additionally or alternatively, photographs can be recorded and stored on the smart device 22 as a record of food consumed. Various other tools or features can also be used to help provide a more accurate estimation of calories consumed.

After receiving food weight measurements, the system 20 can calculate an estimate of the amount of calories consumed. This information can be displayed to the user on a display of the smart device 22 in real time, or periodically. Real-time display can educate users about how many calories they are actually consuming during a meal, in a drink, or in a snack. This information can be combined with the number of calories expended by the user during the day. For example, the smart device 22 can be configured to display the number of calories expended in the day; the number of calories consumed in the day; and/or the number of calories consumed in the current meal, refreshment, or snack. This information is believed to have a large impact on individuals eating and activity behavior, since it can provide fairly real time information of the effect of their actions and even help users know when to stop eating or how much exercise they should be doing. The users can recognize what changes and how much change in their routines and habits is needed to improve their health.

In some embodiments, the smart device 22 include one or more software applications used in conjunction with the peripheral device 24. The software application(s) can be configured to receive and process information from the peripheral device 24 in order to provide an accurate estimation of the actual amount of calories consumed by the user, as described above. This information can be received through one or more user interfaces through which a user can input the type of food being weighed, and whether this is the initial or final weighing of the food item. For example, in the sample shown in FIGS. 3A and 3B, the user can indicate that a beverage is being weighed. In another example, the user can indicate the type of food, such as coffee, green salad, sandwich, etc. The software application can be further configured to receive the type or brand of food or beverage, such as a Starbucks Decaf Willow Blend™.

Some embodiments of the software application can receive and track a user's health goals. For example, a user can input goals related to weight loss, weight gain, calorie consumption, calorie expenditure, exercise activities, exercise consistency, or other such goals. The software application can then track the user's activities and determine if the user is meeting, exceeding, or not meeting their goals. The software application can provide notifications, encouragement, or other messages to the user relating to the users activities and goals. For example, the software application can provide messages to users at the end of the day about whether they met or did not meet their goals for that day. This information can additionally or alternatively be provided on the display of the peripheral device 24.

Embodiments of one or more software applications on the smart device 22 can embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a smart device 22 capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

Reference will now be made to FIGS. 4A through 7B, which depict various embodiments of attachment device that can be used by an individual to carry the peripheral device 24 in a way that will measure the user's activity. To maximize the effect and accuracy of the peripheral device 24 a user can carry the device with them. Without the device, the users cannot measure their activity nor can they weigh their food. Accordingly, the peripheral device 24 can be configured to be used as an everyday object that can be comfortably and naturally carried, toted, or attached to an individual. For example, FIGS. 4A and 4B illustrate the peripheral device 24 coupled to a key chain 52. Because a user may frequently or constantly carry their keys in their pocket or hand, the peripheral device 24 can provide measure the user's movement, and provide an estimate of calorie expenditure, without being overly burdensome or unfashionable. In the embodiments of FIG. 4A, the peripheral device 24 can include a loop 54 or other structure that can be coupled to a key ring of a keychain 52. In FIG. 4B, the peripheral device 24 is coupled to a strap or other ornamental structure that is coupled to the key ring.

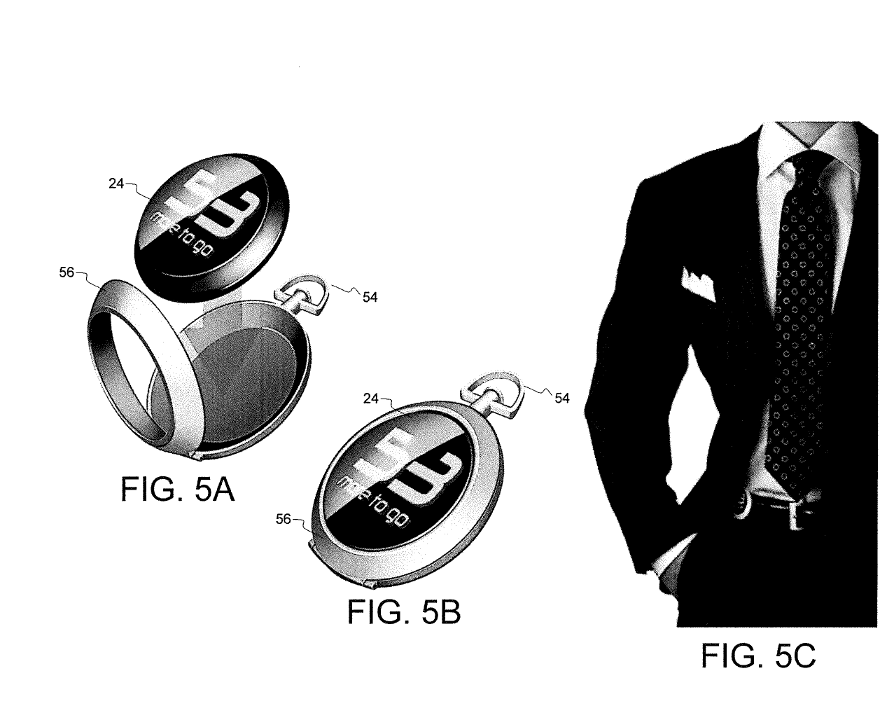

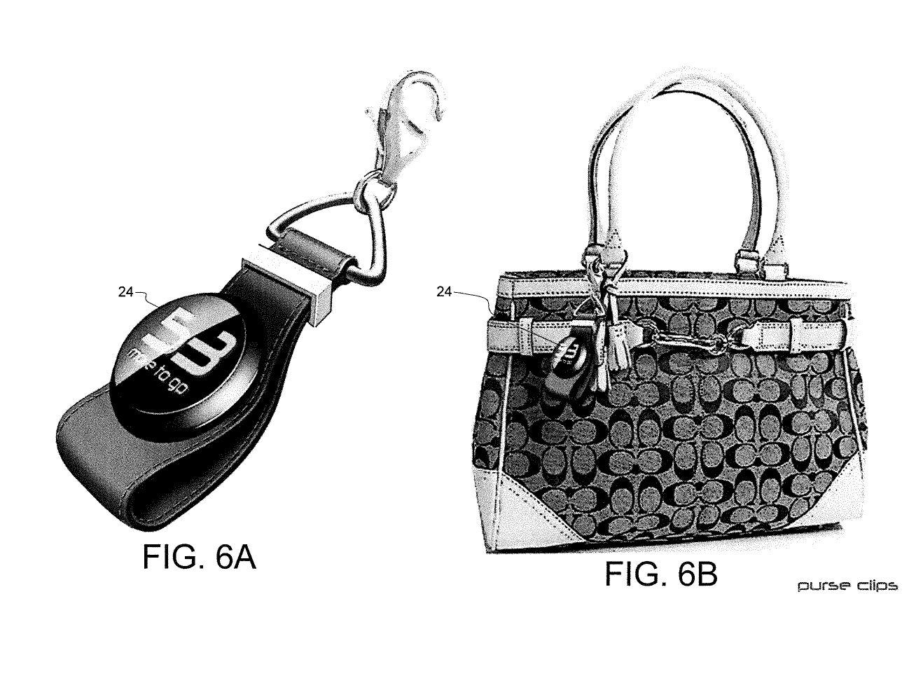

FIGS. 5A, 5B, and 5C illustrates embodiments of a peripheral device 24 that is incorporated into a pocket watch and belt clip. The peripheral device 24 can be inserted into an ornamental attachment device 56, case, or cover that can protect and house the peripheral device 24. As shown, the attachment device 56 can be used as a pocket watch (as shown in FIGS. 5A and 5B) or attached to a belt as a belt clip (as shown in FIG. 5C). When in the pocket or on the belt, the peripheral device 24 will be subject to many or all of the major movements of the user, which can enable to the peripheral device 24 and system 20 to measure and calculate user movement and calorie expenditures. Similarly, FIGS. 6A and 6B show a peripheral device 24 incorporated into a purse clip.

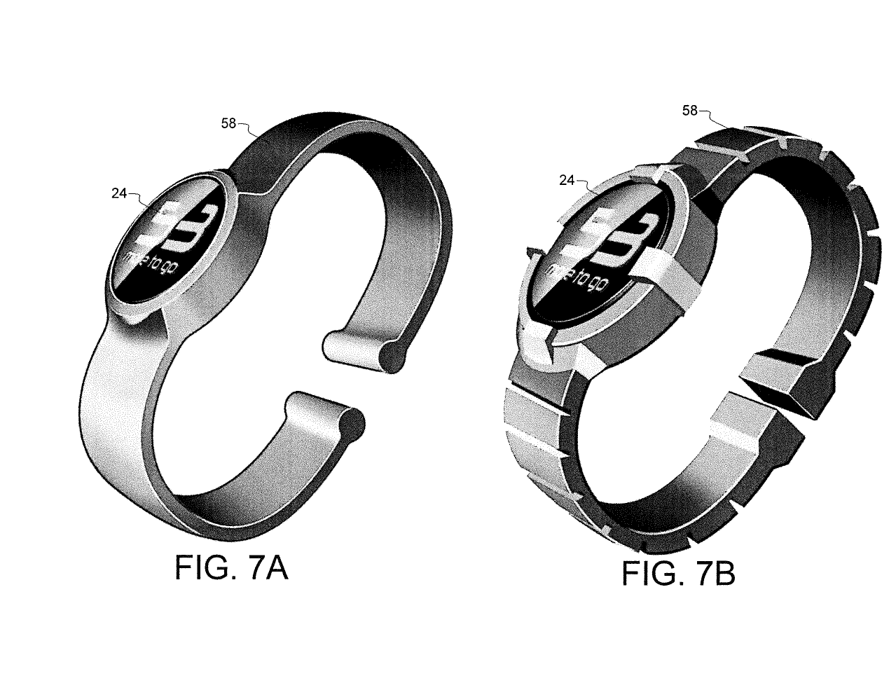

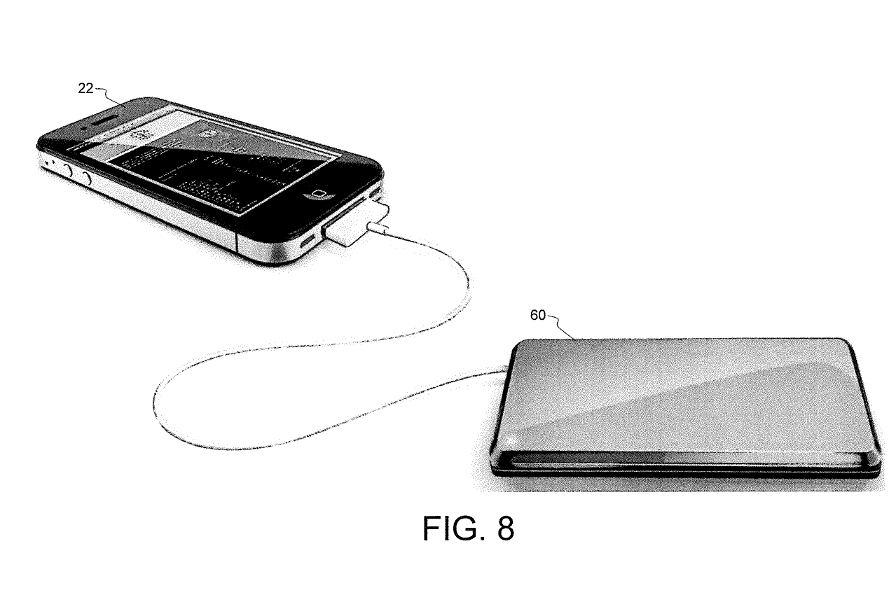

FIGS. 7A and 7B show the peripheral device 24 incorporated into a watch 58. By positioning the peripheral device 24 on the wrist, as with the watch 58, the peripheral device 24 can register a wide range of movements made by the user, including typing, writing, walking, running, etc. Additionally, by attaching the peripheral device 24 directly on the body of the user, the peripheral device can track movements and acquired non-movement measurements, such as temperature and heart rate, as described above.

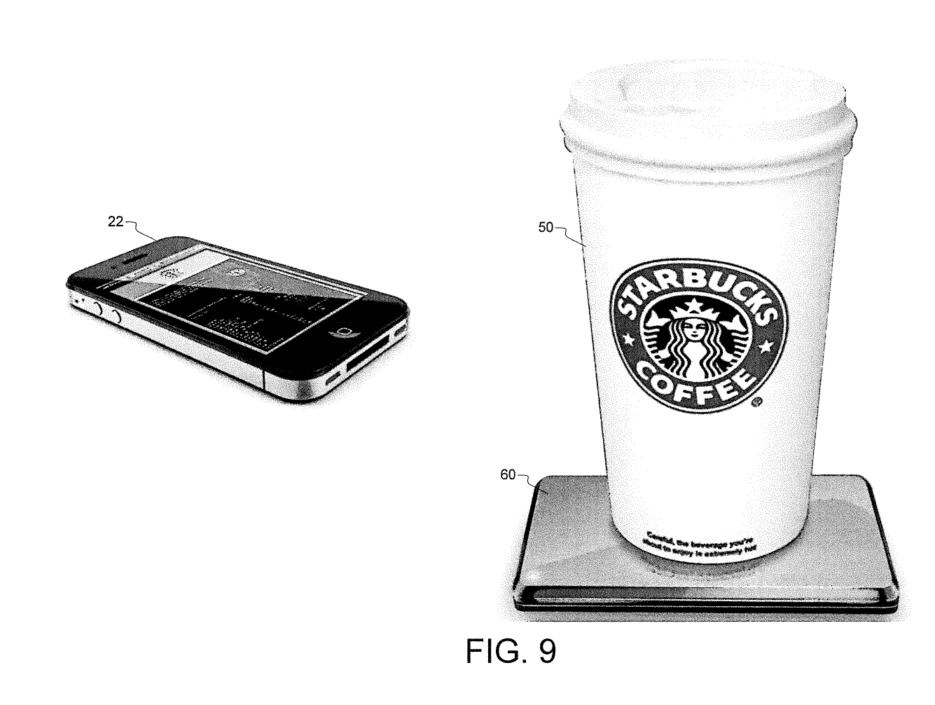

Reference will now be made to FIGS. 8 and 9, which illustrate a food scale 60 peripheral device, which does not necessarily, but can, include movement sensors. As shown, a wired (shown in FIG. 8) or wireless (shown in FIG. 9) food scale 60 can be provided, which can, similar to the peripheral device 24 of FIG. 2, include one or more weight sensors for weighing food. Using the weight sensors, the food scale 60 can weigh one or more food items in a single instance or continuously during a meal or other period. In addition to the embodiment shown in FIGS. 8 and 9, a separate food scale 60 of food scale integrated into a peripheral device 24 with motion sensors 40 (as shown in FIG. 2) can be configured as a tray, place mat, sheet of paper, credit card-type device, or other commonly used structure. Additionally, the separate food scale 60 of food scale integrated into a peripheral device 24 with motion sensors 40 can be configured to be rigid, semi-rigid, or flexible. Furthermore, this structure can be expandable, in order that various shaped and sized items of serviceware can be balanced thereon.

In each of the above described embodiments, peripheral device 24 can be configured with a near field communications (NFC) chip or other NFC component for enabling the peripheral device to communicate with a smart phone or another computer device that is also NFC enabled. Any of the above described types of data can be communicated between peripheral device 24 and another computer device using the NFC standards. In this way, communication between peripheral device 24 and another device can be greatly facilitated.

In light of the foregoing, it will be seen that the present invention provides individuals with systems and methods for calculating their overall calorie intake and expenditure. The present systems can include a smart device that receives data from a peripheral device. The peripheral device can both measure the weight of food and measure a user's activities. These measurements can be used to calculate the user's calorie intake and expenditures.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A system for measuring calorie consumption and expenditure, the system comprising:
a peripheral device having one or more motion sensors and one or more weight sensors;
a smart device in electronic communication with the peripheral device and configured to calculate calorie consumption and expenditure of a user based on data measured from the one or more motion sensors and one or more weight sensors.

2. The system of claim 1, wherein the peripheral device includes a near field communication chip for communicating with the smart device.

3. The system of claim 1, wherein the peripheral device has a maximum length of less than or equal to approximately 3 inches and a maximum width of less than or equal to approximately 1.5 inches, and a maximum thickness of less than or equal to 0.75 inches.

4. The system of claim 1, wherein the peripheral device includes a display screen.

5. The system of claim 1, wherein the peripheral device includes a processor and a memory device.

6. The system of claim 1, wherein the one or more weight sensors includes an accelerometer, altimeter, and/or magnetometer.

7. A peripheral device configured to measure the weight of food and drink items and to measure a user's activity, the peripheral device comprising:
a housing;
one or more motion sensors disposed within the housing; and
one or more weight sensors disposed within the housing;

8. The peripheral device of claim 7, wherein the housing has a maximum length of less than or equal to approximately 3 inches and a maximum width of less than or equal to approximately 1.5 inches, and a maximum thickness of less than or equal to 0.75 inches.

9. The peripheral device of claim 7, wherein the peripheral device includes a display screen disposed at least partially within the housing.

10. The peripheral device of claim 7, wherein the peripheral device further includes a processor and a memory device disposed within the housing.

11. The peripheral device of claim 7, further comprising a device attachment coupled to the housing.

12. The peripheral device of claim 11, wherein the device attachment is a keychain attachment.

13. The peripheral device of claim 11, wherein the device attachment is a belt attachment.

14. The peripheral device of claim 11, wherein the device attachment is a watch attachment.

15. The peripheral device of claim 11, wherein the device attachment is a purse accessory with a clip.

16. The peripheral device of claim 11, wherein the device attachment is an armband.

17. The peripheral device of claim 7, wherein the housing includes one or more electrodes.

18. A method for measuring calorie consumption and expenditure of an individual, the method comprising:
receiving activity measurements from a peripheral device, the peripheral device including one or more motion sensors;
receiving weight measurements from a peripheral device, the weight measurements relating to the weight of food consumed by the individual, the peripheral device including one or more weight sensors; and
calculating the individual's calorie consumption and expenditure based on the received activity measurements and weight measurements from the peripheral device.

19. The method of claim 18, wherein the activity measurements are received from the peripheral device using near field communication standards.

20. The peripheral device of claim 7, further comprising:
a near field communication chip for transferring data to another device.
